(19) United States
(12) Patent Application Publication
(10) Pub. No.: US 2005/0188868 A1
(43) Pub. Date: Sep. 1, 2005

(54) Method for direct engraving of cups to accept the printing ink for rotogravure

(75) Inventor: Siegfried Beisswenger, Preetz (DE)

Correspondence Address: SCHIFF HARDIN, LLP;PATENT DEPARTMENT, 6600 SEARS TOWER, CHICAGO, IL, 60606-6473, US

(73) Assignee: Hell Gravure Systems GmbH

(21) Appl. No.: 10/895,555

(22) Filed: Jul. 21, 2004

(30) Foreign Application Priority Data
Feb. 27, 2004 (EP) 04 004 470.3

(51) Int. Cl. B41C 1/04

(52) U.S. Cl. 101/401.1; 101/150

(57) ABSTRACT

A method for direct engraving of cups to accept printing ink in a surface of print cylinders specified for rotogravure. The engraving is executed such that the cups are formed from a predetermined number of engraved image points.

### BACKGROUND

The invention concerns a method for direct engraving of cups to accept the printing ink in the surface of print cylinders specified for rotogravure.

In contrast to offset printing, in which the conversion of all information of an image or text to be printed occurs by means of a print machine, namely by means of surface elements (here one speaks of surface variability or half-tone plate, since the offset plate or offset roller can only transfer inks of uniform ink layer thickness onto its surface), in rotogravure the formation of cups in the print cylinder is necessary due to the very fluid inks used there, whereby each cup transfers a precise, specific ink volume upon printing. In offset printing, the overall tone value variability is achieved by a variation of the surfaces, whereby one thereby speaks of autotypical print raster points. In rotogravure, for the generation of half-tones that are formed in the interaction of an ink point with the paper of a specific brightness impression surrounding it within the raster mesh, it is not necessary to implement a digitization of half-tone images in the form of “ripped” data because the engraving system used in rotogravure, for example a diamond or also a laser engraving system, which has very advantageous properties can be directly controlled with data corresponding to grey values.

However, a significant problem of rotogravure still exists, in that a sharp reproduction of contours is not yet possible to the degree that would really be desired, and as is enabled by offset printing (which has other disadvantages).

A variation of the conversion of the information of the image to be printed onto the print cylinder in rotogravure is what is known as laser mask exposure of a thin thermal or photosensitive mask layer previously applied on the print cylinder, with subsequent etching. By means of a fine laser beam, the mask is removed or is exposed at locations where a or no cup is to be etched. The cleaning (given a thermal mask) or the development and washing (given a photosensitive mask) of the mask surface subsequently occurs, and then the etching of the uncovered elements of the copper surface subsequently occurs.

Although the formation of sharper contours with edges or characters is possible by means of the previously specified laser mask exposure including the etching, the ink must also be enclosed in cups in this technique. However, in contrast to the electromechanical engraving, partial cups can be designed, whereby sharper contours can be achieved that are not afflicted with what is known as a “sawtooth effect”, for example diamond-engraved characters.

However, since the laser beam can only be used such that it either removes or leaves the mask, i.e. only a yes/no method direction is possible by means of the laser, the cups can likewise only be surface-variably placed in the mask layer, meaning they can only be varied in terms of the number and arrangement of the surface elements composing them. This means that a different depth variation of the individual cups is not possible since all cups are etched equally deep via the etching event.

For the method according to the previously specified laser mask exposure, after generated half-tone data have been generated via scanning or digital photography of an image that is to be printed, it is thus necessary to recode these half-tone data, meaning the grey value (brightness impression) that should generate a raster mesh in the printing and that, for example, should be resolved in 255 increments (1 byte) must be represented as a surface-variable raster point whose elements—the image points—are only bit-coded. This means that half-tones virtually no longer exist, but rather only image points (surface elements) that are written or not. If yes/no information can only be written in the print cylinder in the previously specified manner, a “raster image” (half-tone image) must be generated in which the grey value desired for the respective raster or print mesh is converted into a bit structure (bitmap).

This event that is implemented in what is known as a raster image processor-(RIP) is designated as a “mastering” in the narrow sense in printing technology.

For offset and flexoprinting, what is known as the “ripping” (meaning the conversion of the grey value into surface variable raster points) is always necessary, which is likewise also true for the laser mask coating, which belongs in the group of rotogravure technology. Given the formation of cups, for example by means of an electromechanical engraving event (for example by means of a diamond engraving tool) as it occurs in the formation of cups in rotogravure cylinders, the “ripping” is, as stated, not necessary since this generates the cups in a succession and can be directly controlled with grey values.

However, rotogravure based on the laser mask coating has distinct disadvantages because, as mentioned, the mask can only be written on the surface in variable fashion, and the third dimension (i.e. the cup depth) is the same for all cup sizes and is formed via the same process, namely the etching. It has arisen that this method also leads to quality restrictions in the printed reproduction of the image. The reproducibility of the etching underlies restrictions with regard to this, and it has arisen in the reproduction of half-tone curves that, in particular in an area of high brightness (light), no smooth tone value curve is achieved.

### SUMMARY

It is an object to achieve a rotogravure method: with which the disadvantages of the rotogravure method according to the methods of the laser mask coating, including the subsequent etching, are also prevented; with which a significantly better reproduction of gray value curves (in particular in the region of the lights, is still further improved; that exhibits no limitations with regard to the reproducibility of the method; the many method steps as are necessary in the laser mask coating and the subsequent etching of the print form are done away with; all advantages of the conventional engraving method to form the cups on the print cylinder remain; and the method can be implemented for these purposes by means of engraving devices known in the prior art.

The object is achieved is that the engraving event is executed such that the cups are formed from a predetermined number of engraved image points.

### BRIEF DESCRIPTION OF THE DRAWINGS

FIG. 1 shows four respective prior art cups of different volumes, arranged, as an example, in a raster mesh, as they have been designed until now according to the prior art methods of the classical engraving method of print cylinders for rotogravure by means of an electromagnetic engraving using a diamond end tool;

FIG. 2a illustrates a plurality of raster meshes in the area of a transition from contour to image, generated via a method according to the prior art methods of laser mask exposure and subsequent etching;

FIG. 2b shows a prior art graphical element designed from a plurality of raster meshes;

FIG. 3 illustrates a prior art surface or area variable raster point (half-tone raster point) in a rotogravure machine, realized according to the prior art methods of laser mask exposure, and a schematically associated image line of a laser beam to generate the image points;

FIG. 4 is an example of a rotogravure raster mesh generated according to the present method, with a cup that is composed, for example, of 56 image points engraved at different depths;

FIG. 5a illustrates a raster mesh at the edge of a contour designed according to the present method, and

FIG. 5b illustrates a representation of a graphical element, whereby its contour is comprised of a plurality of correspondingly designed raster meshes in the edge region according to FIG. 5a.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

By means of the present method, a fine engraving tool is directed in a regular raster over the entire surface of the print form to be engraved, such that the cups can be formed from a predetermined number of image points via engraving of the image points. This graphical raster is finer than the selected rotogravure raster that comprises the volume-variable rotogravure cups.

By means of the method, the rotogravure cups are engraved directly in the engraving-bearing surface of the print cylinder, as in the engraving with the assistance of the conventional engraving technique for rotogravure, which is different than in the method according to the laser mask coating. The method steps applied according to the method after the laser mask exposure and the subsequent etching and cleaning are done away with completely in the present method, whereby an exceptional sharpness of the image to be printed is achieved with regard to the actual image and all contours. In addition, the method can in principle be executed by means of existing engraving systems to engrave print cylinders for rotogravure, such that the method can also be used in existing engraving devices in use.

According to an advantageous embodiment, the engraving depth of the image points can be formed differently, meaning the image point volumes (and thus the cup volumes) can be varied via differently selected engraving depths of the individual image points.

The engraving depth of the image points can preferably be designed given the same expansion of the surface elements of the image point, meaning the engraving depth of the image point is no longer correlated with the two-dimensional expansion of the surface element of the image point. It results from this that the data that control the engraving tool used in the method are not coded in what is known as a “bitmap”, as in the laser mask exposure. Rather, it is possible that each individual image point should be capable of being depth-engraved in the aforementioned manner.

The engraving depth can preferably be established in incremental depth intervals; however, it is in principle also possible that the engraving depth is set or controlled via analog control of the engraving tool.

The depth intervals are preferably resolved with optional 1 to 8 bits, preferably 8 bits, such that the maximum 255 different depths can be engraved. However, it is also possible to code the depth resolution with only 2 bits, such that, for example, four depth settings are possible (such as full depth, middle depth, small depth and no engraving). However, depth patterns other than 2-bit are also possible.

The engraving width per raster mesh can also be designed in stepped fashion. It can be advantageous that a cup is comprised of at least one image point and can comprise a maximum of 255 image points, meaning the pattern of the image points that form the cups can grow from 1 to 255 image points.

The two-dimensional surface element of the image point is also preferably variably adjustable with regard to its areal expansion, whereby the areal expansion is advantageously in the range of 10 to 20 μm.

The size of the areal expansion of the surface element of the image point, meaning the size of the image point on the surface of the print form to be engraved, can be selected dependent on the engraving system used for the engraving event.

The system and method makes it advantageously possible that the engraving event is executed such that partial cups can be formed from a predetermined number of image points, such that in particular contours of text and images can be extremely sharply reproduced in the subsequent printing. The formation of partial cups was previously only possible in limited form in the method according to the methods of laser mask exposure, or in offset printing with all typical disadvantages prevalent in these previous printing methods.

It is fundamentally possible to use any suitable engraving system or engraving tools as a way to execute the engraving of the image points that as a whole form a cup. Advantageously suited for this are the classical electromechanical engraving systems, for example a very fine diamond tool; however laser light, in particular pulsed laser light, is preferably used as an engraving system. The laser light can thereby exhibit an arbitrary suitable cross-sectional shape via suitable lens systems and suitable diaphragm systems, such that the image points can be suitably designed corresponding to the cross-section shape of the laser beam.

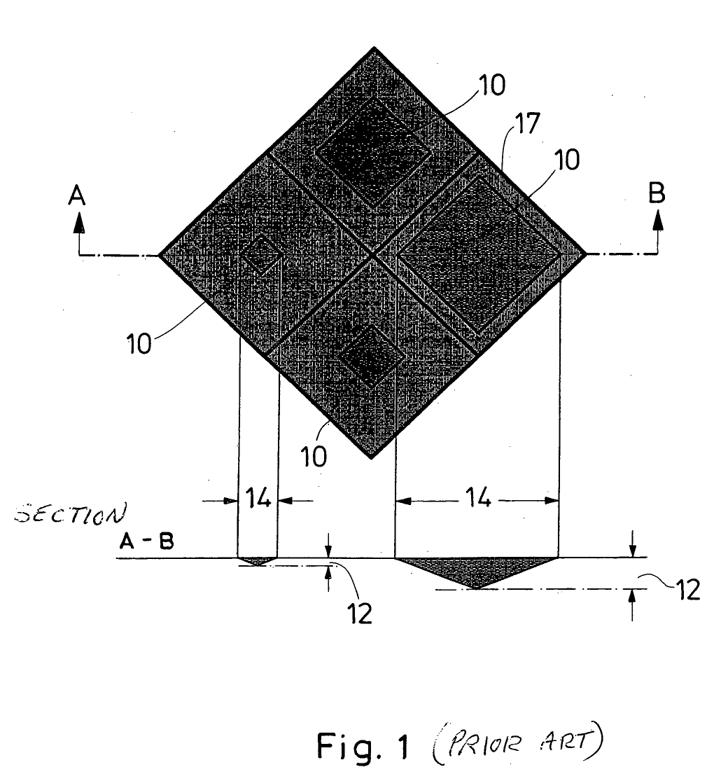

To better understand the method, reference is first made to FIG. 1, in which the principle of the formation of cups in a print cylinder is shown using a conventional engraving method known in the prior art. In the example, a small region that is comprised of 4 cups of different sizes is selected from the entire print cylinder. The actual engraving system is thereby normally a diamond correspondingly formed as an engraving needle. This known engraving method for print cylinders used in rotogravure is generally designated as electromagnetic engraving and has long been known in professional circles, such that it is not necessary here to go further into the specification of the control of the engraving system to form the cups.

A specification of the cups produced by means of electromagnetic engraving exists in that, due to the fixed geometry of the engraving needle, the depth and the diameter (meaning the expanse 14 with exemplary reference in FIG. 1 to the diagonal of a cup 10) are at a specific fixed ratio relative to the engraving depth 12. The print form achieved via electromagnetic engraving is called semi-autotypical rotogravure, since although the cups 10 are variable with regard to their expanse 14 and their engraving depth 12 but are always in a fixed ratio to one another, only the engraving tools (designed differently, for example via a different cut of a diamond needle) can be changed, while the actual engraving event is however fixed.

A further specification of the electromagnetic engraving is that, due to the low-viscosity printing ink used in rotogravure, whole-tone contours (text and line contents) are in principle reproduced with the same print raster made of cups as the images (image contents), and namely in the print raster selected for the respective ink. A certain blurring thereby results for contours (text and line contents) in rotogravure.

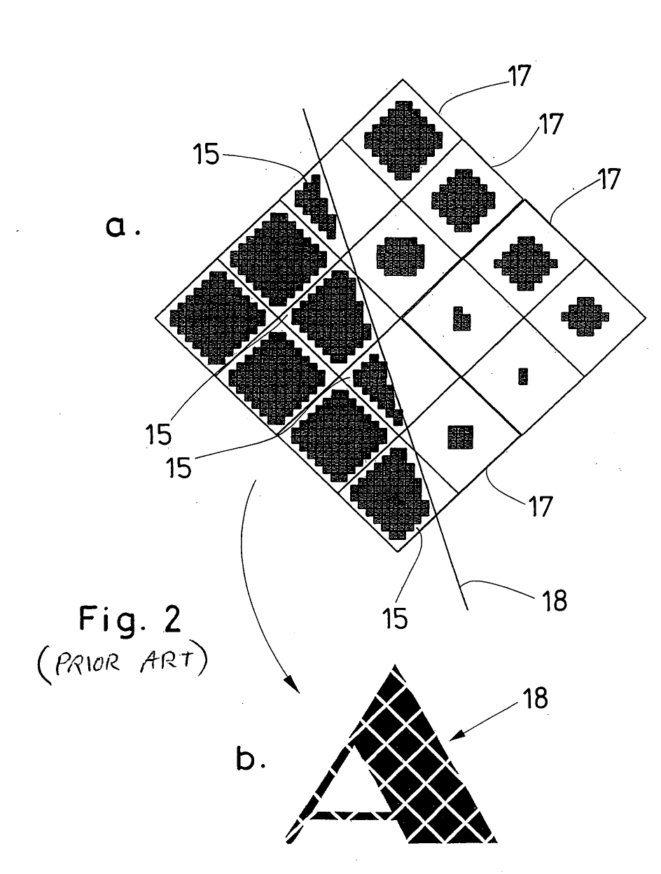

In the formation of cups on print cylinders determined for rotogravure according to the method of laser mask exposure and the subsequent etching (this method or process has likewise long been known in professional circles) in contrast to electromechanical engraving (compare FIG. 2a and 2b), it is possible to design partial cups 15 which apply to both the area of the contour 18 and for the image. In the method of laser mask exposure and subsequent etching, sharper contours 18 are achieved (relative to the contours 18 achieved with the electromechanical engraving of cups 10) that are not afflicted with the “sawtooth effect” that is relatively severe in appearance, for example by means of contours 18 (text and line contents) engraved with diamond needles.

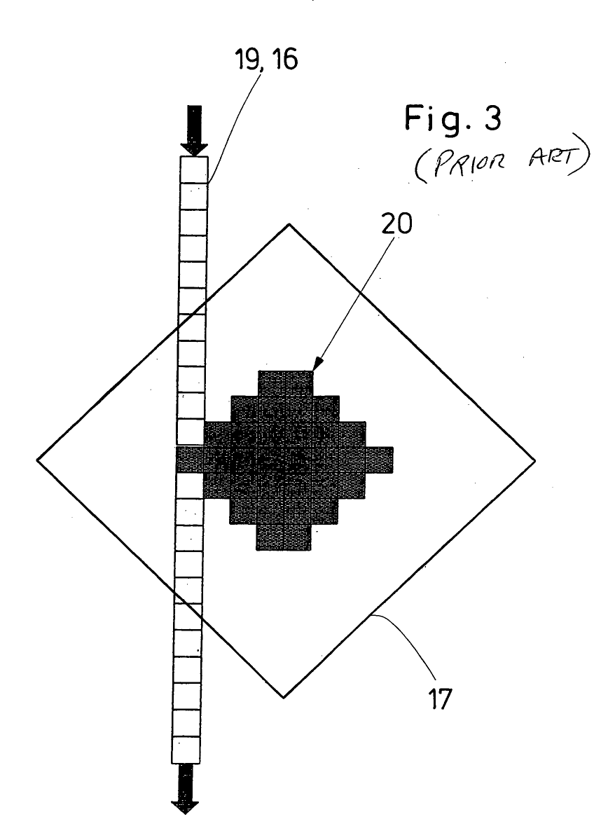

FIG. 3 exemplarily shows a raster point 20 designed by means of the method of laser mask exposure from a plurality of image points which in their entirety form the stated cup 10. Since the laser light writing beam 19 in this known method can only indicate “yes” or “no”, meaning the mask previously applied to the print cylinder can be removed or left in place, the cup thus designed can only be placed in surface variable fashion. The engraving depth 12 is generated in common with equal depth for all cups 10 via the etching event.

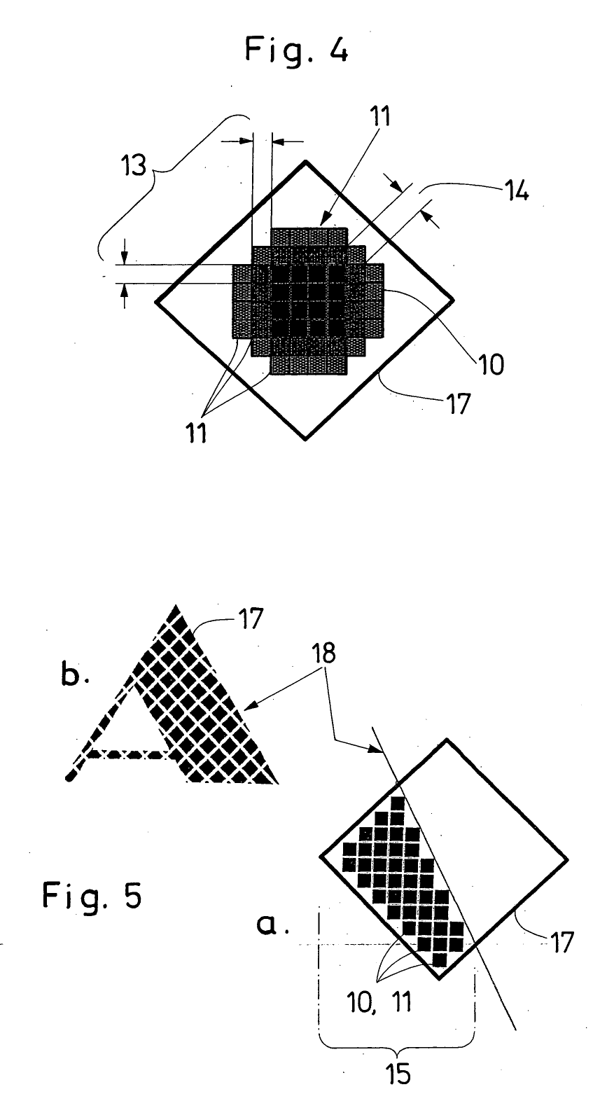

A cup 10 designed in a raster mesh 17 is schematically shown in FIG. 4. The method is thereby executed such that the cups 10 have been formed by means of the engraving event via a suitable engraving system (that can be an electromechanical engraving system but also laser light) from a predetermined number of image points 11, meaning the actual cup 10 is actively formed in the engraving event from a predetermined number of image points 11, also called pixels.

The method can be directed such that each cup 10 can be comprised of an arbitrary number of image points 11 dependent on the predetermined tone values of the image to be printed, whereby a cup 10 is comprised of at least one image point 11 and maximally of the number of image points 11 that are desired based on the program-conditional rastering, for example 255 image points.

In many cases in rotogravure technology a raster mesh is resolved in 255 intervals (corresponding to 1 byte), such that the formation of cups 10 via 255 various patterns of image points 11 represents a reasonable number or relationship.

As is visible from FIG. 4, the engraving depths 12 of the centrally arranged image points 11 (those which appear darkest are deepest; the image points 11 surrounding the central region are in contrast formed less deep, and the outer, encircling image points are formed less deep still) are, for example, designed in the form of a predetermined fixed depth raster, for example represented by 2 bits. Thus, for example, the full depth, the middle depth, the low depth and no engraving could follow the bit-code 11, 10, 01 and 00. However, it is to be noted that finer depth increments can also advantageously be executed than those realizable with 2 bits, for example an 8-bit-deep depth increment.

In the previously mentioned example of the method direction, 255 image points 11 and an engraving depth 12 resolved in 2 bits correspond with more than 1000 attainable values with which a cup 10 can be designed according to the method.

In principle, this high number of more than 1000 adjustable values of the image points 11 per cup 10 represent an over-determination that, however, can be further raised in the printing practice since, from the viewpoint of engraving and printing technology, specific image points 11 of the image point pattern are withdrawn with regard to their engraving depth 12 so that a smooth expression of curves is possible. This withdrawal of the geometric depth in specific regions is experimentally or empirically developed and stored in what are known as “maps for cup configurations”.

As already indicated, in particular the region of the contour 18 (compare FIG. 5a and 5b) can be designed by means of the method such that partial cups 15 can also be formed there from a predetermined number of image points 11. It is thereby achieved that contours 18 can be reproduced as sharp as was previously possible only in offset printing, however with all the advantages of rotogravure in comparison with offset printing.

The expanse 14 of the surface element 13 of image point 11 (compare also to FIG. 1, which shows the formation of the cup 10 by means of conventional electromechanical engraving) can also be variably adjustable and can be made dependent on the actual engraving system, which advantageously can, but does not have to be, laser light 16. When the engraving system is used in the form of laser light 16, it is in principle possible (suitably controlled) to vary the expanse 14 of the surface element 13 of the image point 12 even during the engraving event via suitable control of the laser, whereby an engraving is possible with a still further controllable or influenceable degree of freedom.

In practice, the print density represented by a raster mesh of the engraving raster (whereby the raster has, for example, a resolution of 70 lines/cm) is interpolated from a half-tone image with a higher resolution, for example with 120 lines/cm, such that additional information exists, namely how the density is approximately distributed within an engraving raster mesh. This information can be used for specific shifting of the overall pattern of the image points 11, and thus of the cup 10 comprised of these.

Given print events where the image data do not exist at high-resolution, for example not with 1000 lines/cm but rather only with 120 lines/cm, a very great improvement of the rotogravure, in particular in the contour area, is achieved by means of the method.

All parameters comprised in the image data for the engraving event can thus be used.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

1. A method for direct engraving of cups to accept printing ink in a surface of print cylinders specified for rotogravure wherein the engraving is executed such that the cups are formed from a predetermined number of engraved image points.

2. A method according to claim 1 wherein an engraving depth of the image points can be formed differently.

3. A method according to claim 2 wherein the engraving depth of the image point can be formed differently given a same expansion of a surface element of the image point.

4. A method according to claim 2 wherein the engraving depth is established in stepped depth intervals.

5. A method according to claim 4 wherein the depth intervals are alternatively in a bit pattern of 1 to 8 bits.

6. A method according to claim 5 wherein the bit pattern is 2-bit.

7. A method according to claim 1 wherein a cup is comprised of at least one image point.

8. A method according to claim 1 wherein a cup is comprised of a maximum of 255 image points.

9. A method according to claim 1 wherein a surface element of the image points can be variably set with regard to its surface expanse.

10. A method according to claim 9 wherein the surface expanse is in a range of 10 to 20 μm.

11. A method according to claim 1 wherein the engraving event is executed such that partial cups are formed from a predetermined number of image points.

12. A method according to claim 1 wherein an electromechanical engraver executes the engraving of the image points.

13. A method according to claim 1 wherein a laser light executes the engraving of the image points.

14. A method for engraving of cups to accept printing ink in a surface of a rotogravure print cylinder, comprising the steps of:
with one of a diamond and a laser beam directly forming each of the cups in said surface from a plurality of image points separately engraved in said surface, and wherein at least one of the image points has a depth which is different than a depth of another of said image points.

15. A method of claim 14 wherein the laser beam is used for engraving each image point of each cup.

16. A method of claim 14 wherein the diamond is used for engraving each image point of each cup.

17. A method of claim 14 wherein engraved image points at a periphery of the cup have a depth which is less than a depth of image points inside of said periphery.

18. A method of claim 14 wherein each cup lies within a respective square of a raster mesh.

19. A method of claim 14 wherein each image point of each respective cup has a depth which is one of at least four different depth values.
